(19) United States
(12) Patent Application Publication
(10) Pub. No.: US 2012/0049499 A1
(43) Pub. Date: Mar. 1, 2012

(54) VEHICLE WITH PIVOTABLE MAST ARM ASSEMBLY

(76) Inventors: Ingo Hartweg, Ludinghausen (DE); Siegfried Trümper, Dortmund (DE)

(21) Appl. No.: 13/265,701

(22) PCT Filed: Jul. 8, 2010
(86) PCT No.: PCT/EP10/04174

§ 371 Date: Nov. 14, 2011

(30) Foreign Application Priority Data
Jul. 20, 2009 (DE) 10 2009 033 917.5

(51) Int. Cl. B60S 9/02; B66C 23/78

(52) U.S. Cl. 280/763.1

(57) ABSTRACT

The invention relates to a vehicle comprising a pivotable mast arm and frame supports provided on both sides of the vehicle, wherein at least one frame support includes a support element which is extensible into a support position laterally from the vehicle, wherein the vehicle is supported in the support position against tipping through a support base assembly arranged at the support element, wherein the extension of the support element (27) of at least one frame support (4) is provided along at least one slotted link support (35) through a control curve (35a).

### FIELD

The embodiments disclosed herein relate to vehicles having a swing-out mast arm assembly and frame stanchions provided on both sides of the vehicle.

### BACKGROUND

Vehicles of this type among other things are often used for conveying concrete and similar thick materials and include a concrete pump on the vehicle frame behind the driver cab for conveying concrete and a filling funnel for receiving concrete and a mast arm assembly which typically includes a mast base typically rotatably supported on the vehicle frame with the mast pivotably linked to the mast base. The mast can include two or more mast arms which are pivotably linked with one another and support the concrete feed conduit.

By pivoting out the mast arm which is typically performed by a hydraulic cylinder the concrete feed conduit, at whose end a concrete output hose is arranged can be moved into various positions for putting out concrete.

For vehicles of this type in particular for feeding thick materials like concrete it is important that the vehicle is secured against tipping before the mast arm assembly is pivoted out and concrete is fed in order to prevent accidents during operations. Thus typically frame supports are arranged at the vehicle frame, thus on both sides of the vehicle, wherein the frame supports respectively include an extendable, optionally also telescoping support element, at whose end a respective support base assembly is provided. Through further extension of the support elements and of the support bases arranged thereon the vehicle can be secured against tipping in a position that is supported in four points.

Thus, different configurations for frame supports of this type are known. An advantageous arrangement of the frame supports is a so-called X-arrangement in which e.g. the frame supports arranged in the front portion of the vehicle are arranged so that they cross over one another which causes in particular a compact configuration. A conventional X-arrangement of this type is illustrated in FIG. 1. The disadvantage of this configuration is that the support elements with the support bases arranged thereon can hardly be extended laterally without risking a collision with vehicle components so that the support elements are arranged between the wheel axles or the wheels in order to achieve a compact configuration and a positioning that is secured against tipping. This is problematic in particular for vehicles with plural axles since the support elements with the support bases are then respectively arranged between the adjacent vehicle axles and thus between the respectively associated wheel pair, in particular in view of the fact that tandem wheels are often used. Due to the space constraints there is only limited space, since the support elements have to be arranged at an angle relative to the longitudinal vehicle axis, wherein the angle is substantially predetermined by the space constraints or only variable in an angle range of 1° to 2°. This has the consequence that the support elements often have to be configured very long and with plural telescopes in order to bring the support bases into the required position for safety against tipping. Therefore support element configurations are already known (DE 197 36 108 A1) in which the support elements are pivotably linked with one another so that the support bases can be positioned in a suitable manner, in particular under space constrained conditions on a construction site. In this context it is also known that in particular for a multi-axle configuration the respective frame supports are arranged offset from the axle portion (c.f. DE 197 36 108 A1), which, however has the consequence that the support elements are configured comparatively long and thus have heavy weight. Furthermore a configuration of this type is not compatible with the desired compactness, wherein it is appreciated that the available space on the vehicle frame is very limited due to the additional components like pump, feed conduits, mast arms etc.

It is also appreciated that the support bases have to be extended at least up to the level of the tipping edge lines of the tipping edge triangle or beyond for a positioning that is safe against tipping, wherein the pivot edge triangle is formed by determining a so-called center of gravity circle about the center of gravity of the vehicle, wherein the center of gravity circle is defined by a rotation of 360°, wherein tangents perpendicular and parallel to the vehicle longitudinal axis are applied to the center of gravity circle, wherein the tangents then define the pivot edges and the pivot edge rectangle. In particular for the compact configuration and the X-arrangement of the frame supports with advantageously simple configuration, it often comes as a consequence of the angular position of the frame support relative to the vehicle longitudinal axis that is predetermined by the space constraints that the support elements have to be extended very far into one position in order to reach the forward pivot edge line that extends perpendicular with respect to the vehicle longitudinal axis for the forward frame supports or to position the support bases on this line. This certainly makes it more difficult to configure frame supports that are arranged in an X-shape of this type and this yields a respective weight increase due to the long configurations of the support elements. In principle this can be overcome in that the adjacent vehicle axes between which the frame supports are positioned are placed further apart in the front portion or in the rear portion of the vehicle. Though the installation conditions are improved through the larger distance between the axes for the frame supports to be arranged at an angle relative to the vehicle longitudinal axis, this requires custom fabrication which significantly increases the production cost of the vehicle.

### SUMMARY

Disclosed are embodiments that, under space constraints either through tandem axle configuration of the wheel pairs or through exterior obstacles on the construction site, provide a clear extension of the support elements of frame supports that are arranged in particular in X-configuration for a compact configuration with minimum extension stroke for a positioning of the vehicle that is secured against tilting, wherein the vehicle includes a mast arm assembly. This shall be achieved through simple and compact measures.

In certain embodiments, this is achieved using a support base assembly arranged at a support element that is extendable into a support position laterally from a vehicle, wherein the extension of the support element of at least one frame support is provided along at least one slotted link support through a control curve.

In certain embodiments, at least two associated frame supports are arranged relative to one another in an X-shape along at least one slotted link support with a control curve. Depending on the control curve the support bases are extended along a curve defined by the control curve, which facilitates extending the support bases without collisions also under space constraints, however also a controlled extension of the support elements or movement of the support bases into a desired position is possible independently from the angular position of the permanently installed frame support relative to the longitudinal axis of the vehicle.

For example a control curve of this type that is configured S-shaped facilitates extending the support element with the support bases initially at a comparatively large angle relative to the vehicle longitudinal axis from the edge portion and subsequently at a rather small angle relative to the vehicle longitudinal axis towards the target point, thus the point of tilt safety on the tilt edge line. This substantially increases flexibility while maintaining a compact X-arrangement of the frame supports. This does not only facilitate a collision free extension of the support element with the support base from confined wheel portions, but rather depending on the control curve the support base can be moved to a desirable position also under confined conditions at a construction site without complex pivot mechanisms being required between support element sections within the frame support.

The slotted link support can be configured fixated at the frame, wherein the support element is supported in the slotted link support by a guide element. This, however, is advantageous but not mandatory and a configuration is also conceivable in which the pivot link support is arranged or configured at the support element.

The slotted link support can be formed by a groove shaped control curve in which a guide element engages which is configured in particular at the support element. The guide element operates with the control curve like a cam and is configured in a simple manner by a bolt, pin or a roller. Thus, the support element can also be arranged in a base plate or cover plate of the support element which has the advantage that different control curves can be used by replacing the base plate or the cover plate in adaptation to various conditions.

In certain embodiments, the support element can be provided with a slotted hole in which a guide element engages which is preferably configured as a bolt element. The coupling between the support element and the base plate fixated at the frame, wherein the slotted link support configured as a support fixated to the frame is advantageously configured in the base plate is thus provided so to speak through the bolt fixated at the support element or the guide element and a guide element fixated to the frame which in turn is configured as a bolt or pin. Thus, the slotted hole moves relative to the bolt connected to the frame and the bolt fixated at the support element moves relative to the control curve of the slotted link support in case the slotted link support is configured fixated at the frame.

The slotted hole can be configured at a base plate of the support element. The slotted hole can be configured straight which is advantageous for production, since the curve function or the control function is significantly taken over through the control curve of the slotted link support. A substantially S-shaped control curve has proven practicable in particular, wherein the portion adjacent to the longitudinal vehicle axis is configured with a stronger curve and the portion of the control curve that is remote from the longitudinal axis can be configured straighter. This, however, is always a function of the desired deployment properties which can be adjusted and selected at will through a respective selection of the control curve. It can certainly also be advantageous to configure the support element as a telescoping component thus with two or three telescopes.

At least two or more slotted link supports with different control curves can be provided which increases the number of possible applications. Thus, the initial section of the control curves coincides advantageously and the subsequent portions of the control curves differ. Depending on the selection the respective control curve for the support element and for the support base can be run, wherein it is defined through a switch which control curve is eventually run, though substantially one configuration was described in which the slotted link support is configured below the support element, but configurations are also feasible in which the slotted link support is arranged or provided above or besides the support element.

These and other features, advantages, and objects of the present invention will be further understood and appreciated by those skilled in the art by reference to the following specification, claims, and appended drawings.

### BRIEF DESCRIPTION OF THE DRAWINGS

Subsequently embodiments are described with reference to drawing figures, wherein:

FIG. 1 illustrates a top view of a vehicle with conventionally arranged frame supports in X-arrangement;

FIG. 2 illustrates a lateral view of a vehicle with a new arrangement of frame supports;

FIG. 3 illustrates a partial view of a frame support;

FIG. 4 illustrates a slotted link support mechanism;

FIG. 5 illustrates an embodiment with a slotted link support curve;

FIG. 6 illustrates another embodiment with a different slotted link curve;

FIG. 7 illustrates an embodiment according to FIG. 6, however without illustrating the tilt edge portion.

### DETAILED DESCRIPTION

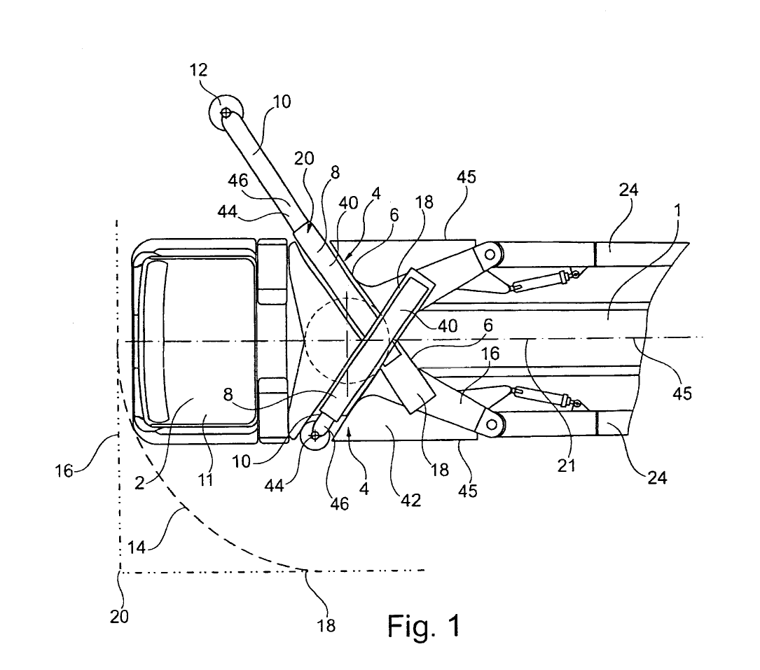

FIG. 1 schematically illustrates a top view of a truck 1 with a cab 2, thus without wheel- or frame assemblies, however, in the vehicle front portion with a conventional frame support assembly in X-shape. In particular the vehicle 1 includes two frame supports 4 arranged in a cross-over or X-shaped configuration in the front portion proximal to the cab, wherein one of the frames supports is respectively oriented towards one vehicle side and the other is oriented towards the other vehicle side. Thus, the frame support 4 oriented upward in FIG. 1 is illustrated in a partially extended position. Each frame support 4 is configured as a telescoping arrangement, thus based on a housing 6 in which a support frame 8 is movably supported which in turn includes a telescoping support element 10 with a support base 12 arranged at the free end and configured in turn in a conventional manner. Typically the support bases 12 are adjustable in a vertical direction and come in contact with the end portion after the telescoping components 8 and 10 are extended, so that a respective support and thus tilt safety is provided. An X-arrangement of this type of frame supports has advantages because it yields a very compact configuration. The disadvantage of this configuration is that in particular when two axes and thus two wheel pairs are provided in the front portion which is often the case for heavy trucks, there is a risk that when deploying the telescoping components 8 and 10 due to the space constraints between the wheel pair between which the frame support 4 is arranged the telescoping components 8 and 10 can only be extended when the frame support is arranged at a predetermined angle. This means the angle for the frame support is predetermined by the space constraints between the front wheel pair in particular in case of two axes since otherwise when deploying the telescoping components 8 and 10 a collision with the wheel pair or the wheel pair accessories like covers etc. can occur. A predetermined angle of this type caused by the limited space between the wheel pairs, however, has the consequence that the frame supports 4 cannot be extended to the tipping edge corners. Extending to the tipping edge corners, however, would be advantageous since it provides an optimum safety of the vehicle against tipping.

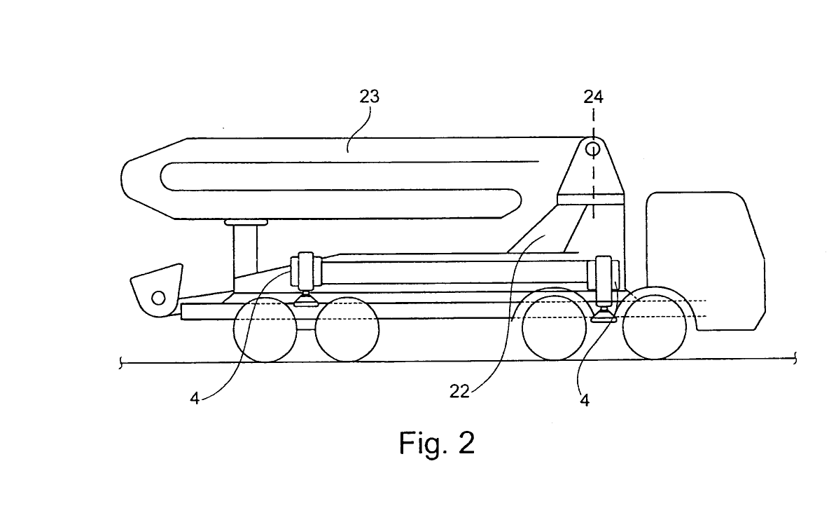

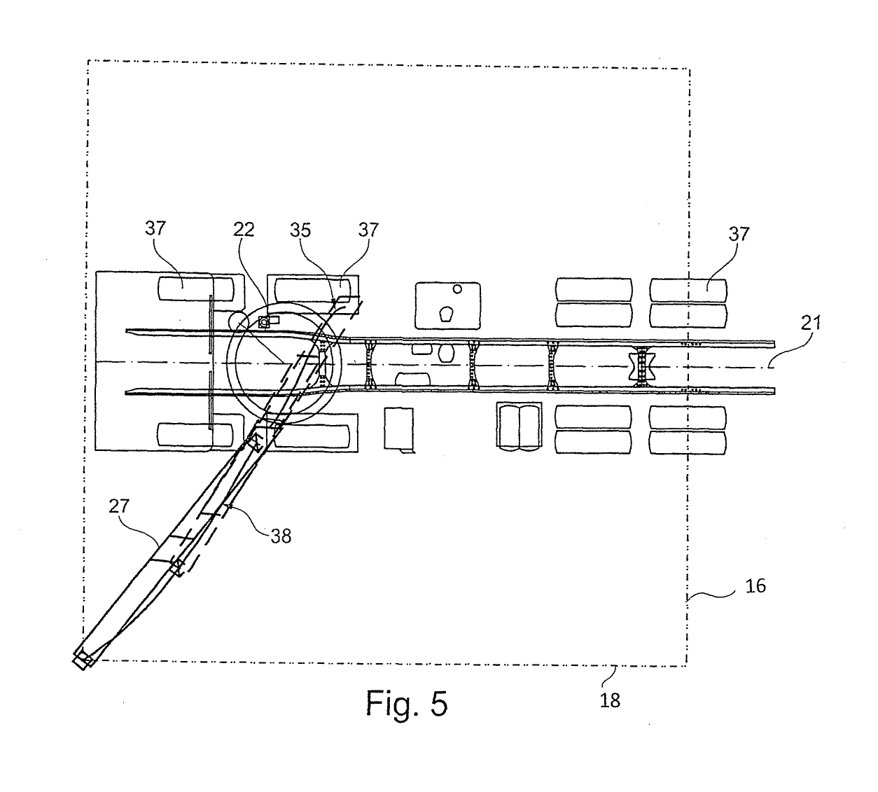

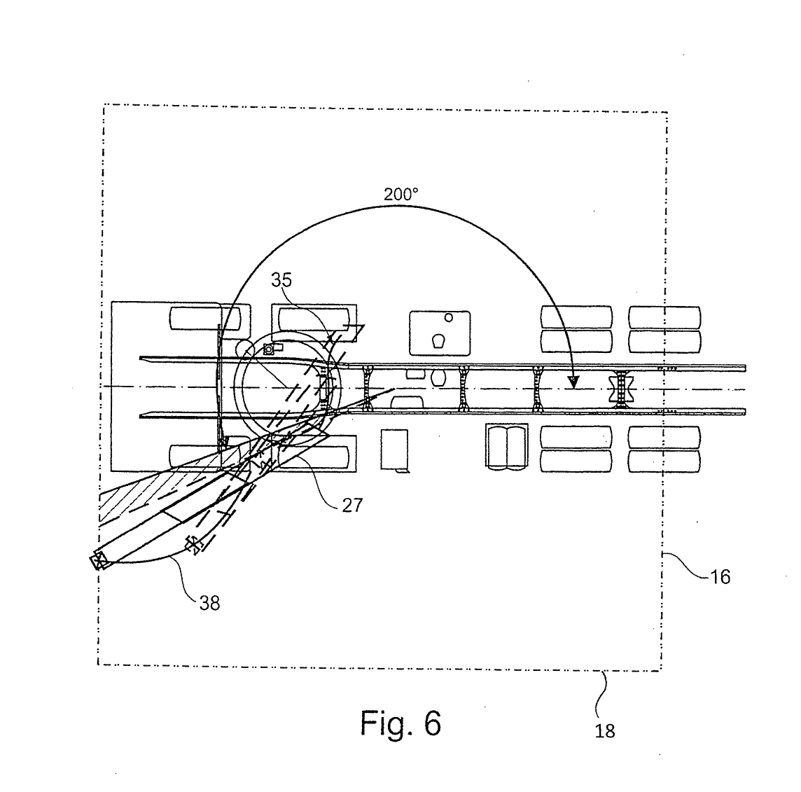

The tipping edges are defined in that for a mast arm that is pivoted out which is e.g. illustrated in FIG. 2 in a position that is pivoted in, the mast that is pivoted out and which can be configured from two or more mast arms is rotated by 360° in a fully pivoted out configuration which defines a so-called center of gravity circle. The tangents that are vertical and parallel to the vehicle longitudinal axis at the so-called center of gravity circle then define a tipping edge rectangle which is illustrated in FIG. 5 through FIG. 6 in dash-double-dotted lines.

For a configuration according to FIG. 1 this has the consequence that the telescoping configuration has to be configured so that the telescoping elements are lengthened accordingly so that the support base 12 can be extended beyond the tipping edge portion and then meets the tipping edge which extends from the cab perpendicular to the vehicle longitudinal axis.

This is illustrated in FIG. 1. Thus, the center of gravity circle 14 is illustrated on the left side in the lower portion, this means in dotted lines in the lower left corner of FIG. 1 and the tipping edges contacting the center of gravity circle 14 as tangents are designated with the numeral 16 for the tipping edge extending perpendicular to the vehicle longitudinal axis and with the numeral 18 for the tipping edge extending parallel to the vehicle longitudinal axis. An optimum point for the tipping safety would be the intersection point of the two tipping edges 16 and 18 which is designated with the numeral 20 herein. However, none of the frame supports can be moved to the tipping edge 20 so that the telescoping elements have to be configured with respective length in order to intersect the extension of the tipping edge line 16 as schematically indicated by the support base 12 and the outer telescoping element 10. Another orientation of the angle at which the frame support 4 is oriented relative to the vehicle longitudinal axis 21 is not possible due to the space constraints and the risk of colliding with vehicle components. On these grounds typically other configurations than the X-configuration are provided for the frame supports in order to avoid the limitations and restrictions recited supra though the X-configuration described supra would otherwise be very advantageous with respect to compactness and also with respect to its mechanical configuration.

FIG. 2 illustrates a truck for describing the configuration according to the invention in which the frame supports 4 are only illustrated schematically and are also arranged in the portion of the forward and the rear wheel pair, since the vehicle includes two axles in front and in the back and therefore includes a forward and a rear wheel pair on each side.

FIG. 2 also illustrates the mast base 22 schematically, wherein the schematically illustrated mast assembly 23 with two arms that are pivotably linked together is illustrated at the mast base. In order to illustrate the center of gravity circle the mast arm 23 would be pivoted out, the center of gravity determined and the circle with respect to this center of gravity about the rotation axis 24 would determine the so-called center of gravity circle for the vehicle. The tangents applied to this center of gravity circle define the tipping edges and thus the tipping edge rectangle.

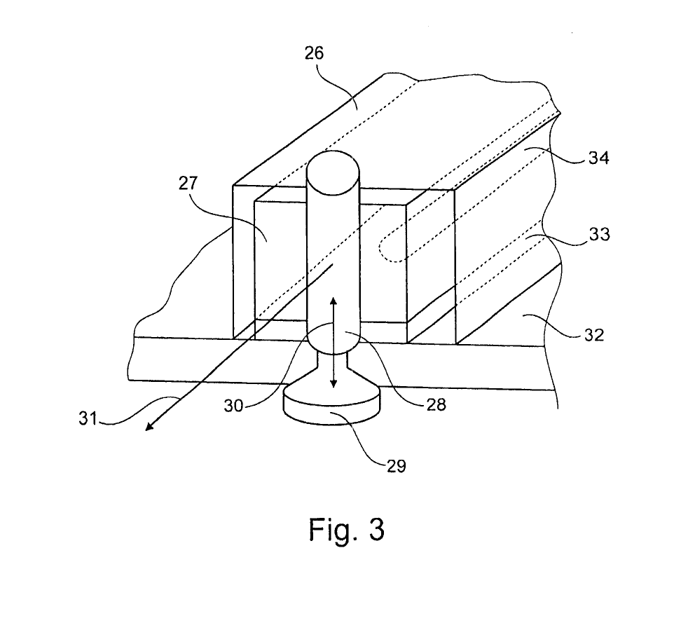

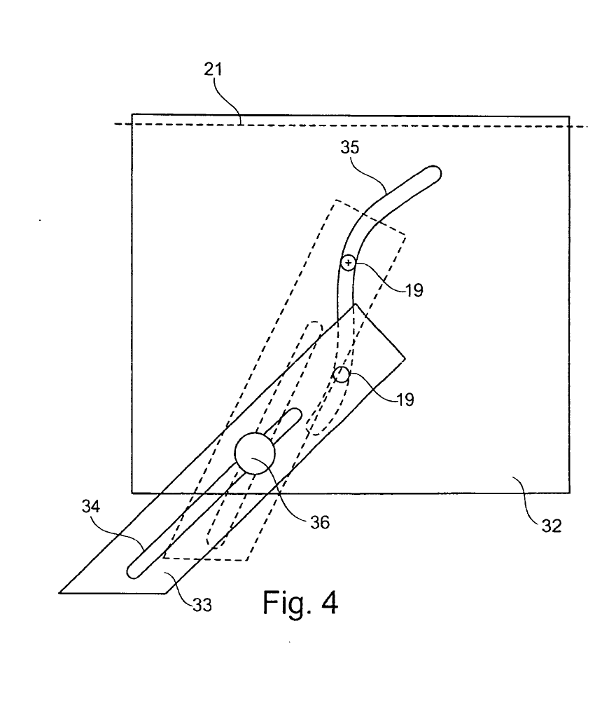

FIGS. 3 and 4 illustrate the configuration according to the invention which facilitates a suitable extension of the elements of the frame support 4 namely without collision risk in spite of the space constraints as they are provided e.g. for two axles in the front portion and in the rear portion of a truck.

FIG. 3 illustrates the frame support 4 in a schematic partial sectional view, wherein the frame support includes a housing 26 and a support element 27 movably supported therein, wherein a conventional support base assembly 28 is arranged at the free end of the support element 27, wherein the support base assembly 28 receives a support base 29 which can be extended in a vertical direction towards the base into a support position. This is illustrated by the arrow 30. The arrow 31 illustrates the extension movement of the support element 27 in order to extend the support base assembly 28 accordingly. The extension is typically performed through a hydraulic cylinder or similar.

The frame support 4, in particular the housing 26 is arranged at the vehicle on a base plate 32 that is fixated at the housing. The box shaped support element 27 includes a base plate 33 at its bottom side wherein the base plate includes a slotted hole 34 which extends in a straight line in the base plate 33. In order to better understand the mechanism, reference is made to FIG. 4 in which the frame mounted base plate is designated in turn with the numeral 32. A slotted link support 35 is configured in the base plate 32 and thus as a slotted link curve herein with substantially S-shaped path, wherein the slotted link curve 35 is formed by a groove.

Furthermore the base plate 33 of the support element 27 is evident from FIG. 4, wherein the base plate is only illustrated schematically and provided with the slotted hole 34 described supra. Thus, the slotted hole 34 communicates with a bolt 36 fixated at the base plate 32, wherein the bolt reaches through the slotted hole 34 and is expanded on top. Thus, the base plate 33 can be moved relative to the bolt 36. Furthermore a downward protruding bolt 19 is connected with the base plate 33, wherein the bolt extends into the curved groove of the slotted link support 35, engages the slotted link support and acts as a cam.

Thus the slotted link support configured as a curve does not provide a purely translatoric extension of the support element out of the housing like in the prior art, but the support element 27 is rather supported according to the control curve.

This is indicated in FIG. 4 through two intermediary positions, namely the position of the base plate 33 that is illustrated dash-dotted, wherein the base plate 33 encloses a larger angle with the vehicle longitudinal axis that is schematically illustrated in FIG. 4, than with the additional intermediary position which is illustrated with solid lines. It is evident that the base plate 33 pivots and thus the support element 27 which is movably arranged in the housing 26 this means in a slideable manner according to the curved path of the slotted link support 35 so that in the second position with solid line the angle between the base plate 33 and the vehicle longitudinal axis 21 is smaller than in the dash-dotted position of the base plate 33 and of the support element 27.

This means a suitable curve facilitates extending the support element 27 from the housing 26 at a greater angle relative to the vehicle longitudinal axis so that a collision with vehicle components can also be avoided under space constraints e.g. between a wheel pair. When the base plate 33 and the support element 27 are deployed further the support element can be pivoted in a suitable manner through a respective curve path so that an alignment with the tipping edges can be provided accordingly.

This is particularly apparent from FIGS. 5 through 7, wherein a schematic illustration was used for reasons of clarity.

The vehicle that is illustrated schematically in top view in FIG. 5 includes two axles in its front portion and thus two wheel pairs on each side and also in the back portion, wherein the wheels are designated with the numeral 37. Also the mast base 22 behind the vehicle cab 2 is only schematically illustrated like the slotted link curve 35 which is slightly curved in the upper portion and then extends in a broadened manner but forms an elongated S overall, wherein the upper S-portion in the figure has a stronger curvature.

The extensible support element 27 is thus illustrated in three positions, namely in the extended position with the solid line, wherein the support element is configured in a telescoping manner, this means it includes another support element arranged on the inside which can be deployed in a relative manner and which supports the support base assembly 12 indicated by a rectangle at its free end. This furthermore yields an intermediary position and a starting position, wherein the angle between the support element 27 and the vehicle longitudinal axis 21 changes according to the path of the slotted link curve 35. The curve path of the support base is indicated by the arcuate line 38 in FIG. 5.

The tipping edge rectangle can also be derived from FIG. 5, wherein the tipping edge rectangle includes tipping edges 16 defined perpendicular to the vehicle longitudinal axis and tipping edge lines 18 defined parallel to the vehicle longitudinal axis. It is apparent from FIG. 5 that the control curve of the slotted link support 35 is configured so that the support element 27 can be easily deployed from the vehicle without risking a collision and is then pivoted so that the support base 12 is exactly positioned in the corner which is defined by the intersection of the tipping edge lines 16 and 18.

However, depending on the application the support base assembly 12 does not have to be extended to the intersection of the tipping edge lines 16 and 18 as evident from FIG. 6.

FIG. 6 provides an illustration where the pivot movement of the mast arm is limited to an angle of 200° as apparent from FIG. 6. This limitation of the pivot angle can be provided in several ways, in particular through control and regulation. Furthermore FIG. 6 uses like numerals for like components. It is apparent that FIG. 6 yields a more defined S-curve for the slotted link support 35 which in turn is configured as a curved groove. As described supra in the context with FIGS. 3 and 4 three different intermediary positions of the support element 27 are also provided in FIG. 6. Also this provides that starting from a position with a greater angle relative to the vehicle longitudinal axis 21 the support element 27 pivots with the extension movement inward towards the vehicle longitudinal axis 21, thus encloses a smaller angle with the vehicle longitudinal axis 21. Due to the limitation of the pivot movement of the mast arm it is sufficient that the support element 27 is aligned with the tipping edge line 16, so that the support base assembly 12 reaches the level of the tipping edge line 16, thus the support base assembly does not have to be moved into the corner, this means into the intersection point between the tipping edge line 16 and 18. The slotted link support with a limitation for the pivot angle of the mast arm is helpful when the support bases cannot be fully extended due to an obstacle at a construction site.

Thus, depending on the slotted link curve 35 an accordingly controlled extension movement of the support element 27 can be facilitated in adaptation to predetermined criteria which yields significant advantages over the translatoric or overall defined extension movements of the conventional frame supports. FIG. 6 in turn illustrates the curve path 38 for the support base assembly 12. The hatching also indicates a safety zone which means that the support base outside of this zone shall be positioned on the tipping edge line.

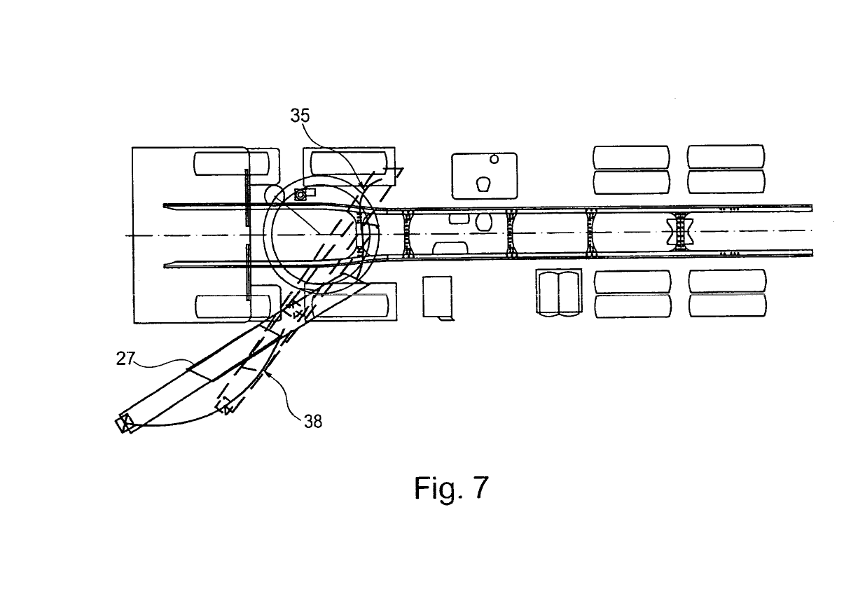

FIG. 7 corresponds to FIG. 6, however the tipping edge rectangle is not illustrated herein anymore for reasons of clarity and also the pivot limitation to 200°. However, three intermediary positions of the support element 27 and in particular the slotted link curve 35 and the curve of the support base assembly 12 are visible quite well.

In combination with the described embodiment the slotted link support is respectively provided as a curved groove in a base plate that is fixated to the frame but it can also be configured as a slotted link support in the support element, in particular in its base plate, wherein the slotted hole arrangement can then be configured in the base plate. Furthermore the invention is not limited to this configuration, the slotted link support can rather be applied laterally or in particular above the support element thus in the cover plate of the housing 26, wherein the slotted hole can be configured in the cover plate of the support element 27. In the same manner the fixated pin 36 and the bolt 19 supported in the slotted link support are provided accordingly in the upper portion between the support element and the housing 26.

Thus it is within the scope of the invention that plural slotted link supports, in particular configured as curved grooves can be provided which can be connected by the switches as required so that the support element and the support base assembly arranged at the free end of the support element can follow two or more different curve paths as a function of the switch position. This is possible in particular without greater complexity when implementing only two slotted link supports which e.g. have the same curve start at the beginning of the extension movement. Thereafter two different curve paths are joined and it can be determined as a function of the switch position how far the cam or the support bolt 19 have to follow one curve path or another. This facilitates implementing two different extension movements for the support base assembly.

1-12. (canceled)

13. A vehicle comprising a pivotable mast arm and frame supports provided on both sides of the vehicle, wherein at least one frame support includes a support element which is extensible into a support position laterally from the vehicle, wherein the vehicle is supported in the support position against tipping through a support base assembly arranged at the support element, wherein the extension of the support element of at least one frame support is provided along at least one slotted link support through a control curve.

14. A vehicle according to claim 13, wherein the slotted link support is fixated at the vehicle frame and the support element is supported in the slotted link support through a guide element.

15. A vehicle according to claim 13, wherein the slotted link support is formed by a groove shaped control curve which is engaged by the guide element which is preferably configured as a bolt, pin or roller.

16. A vehicle according to claim 14, wherein the slotted link support if formed by a grove shaped control curve which is engaged by the guide element which is preferably configured as a bolt, pin or roller.

17. A vehicle according to claim 13, wherein the support element is provided with a slotted hole which is engaged by a frame mounted guide element.

18. A vehicle according to claim 17, wherein the guide element engaging the slotted hole is arranged further from the vehicle longitudinal axis than the guide element engaging the slotted link support.

19. A vehicle according to claim 13, wherein the slotted hole is configured in a base plate of the support element.

20. A vehicle according to claim 13, wherein the slotted hole is configured straight.

21. A vehicle according to claim 13, wherein the control curve is substantially S-shaped.

22. A vehicle according to claim 13, wherein the support element is configured as a telescoping component.

23. A vehicle according to claim 13, wherein the control curve is configured so that the support element is extensible from the side of the vehicle without colliding with vehicle components of the vehicle.

24. A vehicle according to claim 13, wherein at least two slotted link supports with a different control curve paths are provided for a support element, wherein preferably the initial section of both control curves coincides and the diverging curve sections of both control curves connecting thereto are alternatively connectable through a switch.

25. A vehicle according to claim 13, wherein the slotted link support is provided at the base, at the top or laterally from the support element.

26. A vehicle comprising a pivotable mast arm and frame supports provided on both sides of the vehicle comprising:
at least one frame support having a support element extendable into a support position laterally from the vehicle;
a support base assembly arranged at the at least one frame support for supporting the vehicle in the support position against tipping; and
wherein the extension of the support element is provided along at least one slotted link support through a control curve that is fixed at the vehicle frame.

27. A vehicle comprising a pivotable mast arm and frame supports provided on both sides of the vehicle comprising:
at least one frame support having a support element extendable into a support position laterally from the vehicle;
a guide element engaged in a slotted hole for supporting the support element;
a support base assembly arranged at the at least one frame support for supporting the vehicle in the support position against tipping; and
wherein the extension of the support element is provided along at least one slotted link support through a control curve that is fixed at the vehicle frame.
